(19) United States
(12) Patent Application Publication
(10) Pub. No.: US 2026/0241931 A1
(43) Pub. Date: Aug. 20, 2026

(54) COLLISION AVOIDANCE ASSISTANCE APPARATUS, COLLISION AVOIDANCE ASSISTANCE METHOD, AND COLLISION AVOIDANCE ASSISTANCE PROGRAM

(71) Applicants: DENSO CORPORATION, Kariya-City (JP); TOYOTA JIDOSHA KABUSHIKI KAISHA, Toyota-shi (JP); J-QuAD DYNAMICS Inc., Tokyo (JP)

(72) Inventor: Kohei MIYACHI, Tokyo (JP)

(21) Appl. No.: 19/541,937

(22) Filed: Feb. 17, 2026

(30) Foreign Application Priority Data
Feb. 19, 2025 (JP) 2025-025073

(51) Int. Cl. B60W 30/095

(52) U.S. Cl. CPC B60W 30/0956; B60W 30/0953; B60W 2420/408

(57) ABSTRACT

A collision avoidance assistance apparatus acquires information relating to a target behind an own vehicle and information relating to the own vehicle, and performs collision avoidance assistance relating to collision avoidance between the own vehicle and the target, based on the information relating to the target and the own vehicle. The assistance apparatus does not perform the collision avoidance assistance in response to a turning circle and a target path not intersecting and a time-to-collision between the own vehicle and the target being equal to or less than a time threshold, where the turning circle corresponds to a movement path when the own vehicle makes a rearward turn, and the target path is a movement path of the target. The assistance apparatus performs the collision avoidance assistance in response to the turning circle and the target path intersecting and the time-to-collision being equal to or less than the time threshold.

### CROSS-REFERENCE TO RELATED APPLICATIONS

This application is based on and claims the benefit of priority from Japanese Patent Application No. 2025-025073, filed on Feb. 19, 2025. The entire disclosure of the above application is incorporated herein by reference.

### BACKGROUND

The present disclosure relates to a collision avoidance assistance apparatus, a collision avoidance assistance method, and a collision avoidance assistance program.

Conventionally, a vehicle collision avoidance assistance apparatus is known that performs collision avoidance control for avoiding a collision between an own vehicle and a target ahead of the own vehicle, when a collision condition is met while a prohibition condition is not met.

### SUMMARY

One aspect of the present disclosure provides a collision avoidance assistance apparatus that acquires information relating to a target behind an own vehicle and information relating to the own vehicle, and performs collision avoidance assistance that is assistance relating to collision avoidance between the own vehicle and the target, based on the information relating to the target and the information relating to the own vehicle. The collision avoidance assistance apparatus does not perform the collision avoidance assistance, in response to a turning circle and a target path not intersecting and a time-to-collision between the own vehicle and the target being equal to or less than a time threshold, where the turning circle corresponds to a movement path when the own vehicle makes a rearward turn, and the target path is a movement path of the target. The collision avoidance assistance apparatus performs the collision avoidance assistance in response to the turning circle and the target path intersecting and the time-to-collision being equal to or less than the time threshold.

### BRIEF DESCRIPTION OF THE DRAWINGS

In the accompanying drawings:

FIG. 1 is a configuration diagram illustrating an own vehicle in which a collision avoidance assistance apparatus according to a first embodiment is used;

FIG. 2 is a diagram illustrating a vehicle coordinate system of the own vehicle and a target;

FIG. 3 is a flowchart illustrating processes performed by the collision avoidance assistance apparatus;

FIG. 4 is a diagram illustrating a curve radius calculated by the collision avoidance assistance apparatus;

FIG. 5 is a diagram illustrating a turn radius, a turn center, and a turning circle calculated by the collision avoidance assistance apparatus;

FIG. 6 is a diagram illustrating a target path calculated by the collision avoidance assistance apparatus;

FIG. 7 is a diagram illustrating a distance from the turn center to the target path calculated by the collision avoidance assistance apparatus;

FIG. 8 is a diagram illustrating an assistance line and a vector line calculated by the collision avoidance assistance apparatus;

FIG. 9 is a flowchart illustrating processes performed by a collision avoidance assistance apparatus according to a second embodiment; and

FIG. 10 is a diagram illustrating the turn radius, the turn center, the turning circle, the target path, and the distance from the turn center to the target path calculated by the collision avoidance assistance apparatus.

### DESCRIPTION OF THE EMBODIMENTS

Conventionally, as described in JP 2023-047497 A, a vehicle collision avoidance assistance apparatus that performs collision avoidance control for avoiding a collision between an own vehicle and a target ahead of the own vehicle, when a collision condition is met while a prohibition condition is not met, is known. The collision avoidance control is control performed to forcibly brake and stop the own vehicle before the collision with the target, regardless of an accelerator pedal operation or a brake pedal operation by a driver. The prohibition condition is met when a collision angle is equal to or greater than a predetermined collision angle threshold. The collision angle is an amount by which, at an intersecting point between a turning path of the own vehicle and a movement path of a target, a traveling direction of the own vehicle deviates from a line perpendicular to the movement path. The collision condition is met when the own vehicle is likely to collide with the target.

A vehicle collision avoidance assistance apparatus such as that described in JP 2023-047497 A performs the collision avoidance control to avoid a collision with a target ahead of the own vehicle, but does not perform collision avoidance control to avoid a collision with a target behind the own vehicle. In addition, the own vehicle not only makes a forward turn but also a rearward turn. Therefore, an apparatus that assists in collision avoidance between the own vehicle and a target behind the own vehicle when the own vehicle makes a rearward turn is needed.

It is thus desired to provide a collision avoidance assistance apparatus that assists in collision avoidance between an own vehicle and a target behind the own vehicle when the own vehicle makes a rearward turn, a collision avoidance method, and a collision avoidance program.

A first exemplary embodiment of the present disclosure provides a collision avoidance assistance apparatus including: an acquiring unit that acquires information relating to a target behind an own vehicle and information relating to the own vehicle; and an assisting unit that performs collision avoidance assistance that is assistance relating to collision avoidance between the own vehicle and the target, based on the information relating to the target and the information relating to the own vehicle, in which the assisting unit does not perform the collision avoidance assistance in response to a turning circle and a target path not intersecting, and a time-to-collision between the own vehicle and the target being equal to or less than a time threshold, where the turning circle corresponds to a movement path when the own vehicle makes a rearward turn, and the target path is a movement path of the target, and the assisting unit performs the collision avoidance assistance in response to the turning circle and the target path intersecting and the time-to-collision being equal to or less than the time threshold.

A second exemplary embodiment of the present disclosure provides a collision avoidance assistance method including: acquiring information relating to a target behind an own vehicle and information relating to the own vehicle; and performing collision avoidance assistance that is assistance relating to collision avoidance between the own vehicle and the target, based on the information relating to the target and the information relating to the own vehicle, in which performing the collision avoidance assistance includes not performing the collision avoidance assistance in response to a turning circle and a target path not intersecting and a time-to-collision between the own vehicle and the target is equal to or less than a time threshold, where the turning circle corresponds to a movement path when the own vehicle makes a rearward turn, and the target path is a movement path of the target, and performing the collision avoidance assistance in response to the turning circle and the target path intersecting and the time-to-collision being equal to or less than the time threshold.

A third exemplary embodiment of the present disclosure provides a collision avoidance assistance program that causes a collision avoidance assistance apparatus to function as: an acquiring unit that acquires information relating to a target behind an own vehicle and information relating to the own vehicle; and an assisting unit that performs collision avoidance assistance that is assistance relating to collision avoidance between the own vehicle and the target, based on the information relating to the target and the information relating to the own vehicle. The assisting unit does not perform the collision avoidance assistance in response to a turning circle and a target path not intersecting, and a time-to-collision between the own vehicle and the target being equal to or less than a time threshold, where the turning circle corresponds to a movement path when the own vehicle makes a rearward turn, and the target path is a movement path of the target. The assisting unit performs the collision avoidance assistance in response to the turning circle and the target path intersecting and the time-to-collision being equal to or less than the time threshold.

As a result, assistance is provided for collision avoidance between the own vehicle and the target behind the own vehicle when the own vehicle makes a rearward turn.

Here, reference numbers in parentheses attached to the constituent elements and the like indicate examples of corresponding relationships between the constituent elements and the like and specific constituent elements and the like described according to the embodiments described hereafter.

Embodiments will hereinafter be described with reference to the drawings. Here, sections according to the embodiments below that are identical or equivalent to each other are given the same reference numbers. Descriptions thereof are omitted.

### First Embodiment

A collision avoidance assistance apparatus that executes a collision avoidance assistance method and a collision avoidance assistance program according to a present embodiment assists in collision avoidance between an own vehicle and a target behind the own vehicle when the own vehicle makes a rearward turn. First, the own vehicle in which the collision avoidance assistance apparatus is used will be described.

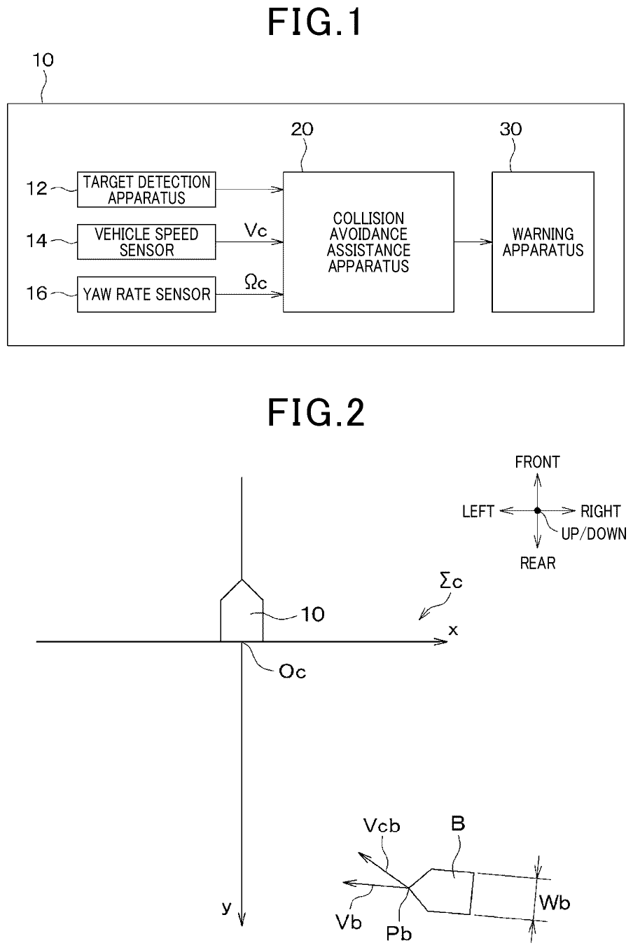

As shown in FIG. 1, an own vehicle 10 includes a target detection apparatus 12, a vehicle speed sensor 14, a yaw rate sensor 16, a collision avoidance assistance apparatus 20, and a warning apparatus 30.

The target detection apparatus 12 detects a target B behind the own vehicle 10 as shown in FIG. 2, using a radar that uses radio waves such as millimeter waves, a LiDAR, a sonar, a camera, or the like. Here, LiDAR is an abbreviation for Light Detection and Ranging/Laser Imaging Detection and Ranging.

Here, an xy coordinate system of which a point of origin Oc is a center of a rear end of the own vehicle 10 serves as a vehicle coordinate system 2c. For example, a right side of the own vehicle 10 may be a positive x-direction. A rear of the own vehicle 10 is a positive y-direction.

In addition, the target detection apparatus 12 calculates a position Pb of the detected target B, a size of the target B, a target velocity vector Vb, and a relative velocity vector Vcb. For example, the position Pb of the target B may be a center position on a front end of the target B in the vehicle coordinate system Σc. For example, the size of the target B may be a width Wb of the target B that is a length of the target B in a direction perpendicular to a direction of the target velocity vector Vb. The target velocity vector Vb is a ground velocity vector of the target B, and in this case is a velocity vector of the target B relative to the point of origin Oc. The relative velocity vector Vcb is a vector of a relative velocity of the target B to the own vehicle 10. Furthermore, the target detection apparatus 12 outputs, to the collision avoidance assistance apparatus 20 described hereafter, the calculated position Pb of the target B, size of the target B, target velocity vector Vb, and relative velocity vector Vcb as information relating to the target B.

Returning to FIG. 1, the vehicle speed sensor 14 outputs a signal corresponding to a vehicle speed Vc of the own vehicle 10 to the collision avoidance assistance apparatus 20 described hereafter. Here, the vehicle speed Vc of the own vehicle 10 is a speed of the own vehicle 10.

The yaw rate sensor 16 outputs a signal corresponding to a yaw rate Ωc of the own vehicle 10 to the collision avoidance assistance apparatus 20 described hereafter.

The collision avoidance assistance apparatus 20 is mainly configured by a microcomputer or the like, and includes a central processing unit (CPU), a read-only memory (ROM), a flash memory, a random access memory (RAM), an input/output (I/O), a communication interface, a bus line connecting these components, and the like. In addition, the collision avoidance assistance apparatus 20 executes a program stored in the ROM of the collision avoidance assistance apparatus 20. As a result, the collision avoidance assistance apparatus 20 acquires information relating to the target B behind the own vehicle 10 from the target detection apparatus 12. Furthermore, the collision avoidance assistance apparatus 20 acquires signals from the vehicle speed sensor 14 and the yaw rate sensor 16. Then, based on the acquired information and signals, the collision avoidance assistance apparatus 20 outputs a signal to the warning apparatus 30, described hereafter, to activate the warning apparatus 30. As a result, the collision avoidance assistance apparatus 20 assists in collision avoidance between the own vehicle 10 and the target B behind the own vehicle 10 when the own vehicle 10 makes a rearward turn.

Based on the signal from the collision avoidance assistance apparatus 20, the warning apparatus 30 notifies a driver of the own vehicle 10 of the collision between the own vehicle 10 and the target B behind the own vehicle 10 using, for example, text display, sound, and light. As a result, assistance is provided for collision avoidance between the own vehicle 10 and the target B behind the own vehicle 10 when the own vehicle 10 makes a rearward turn.

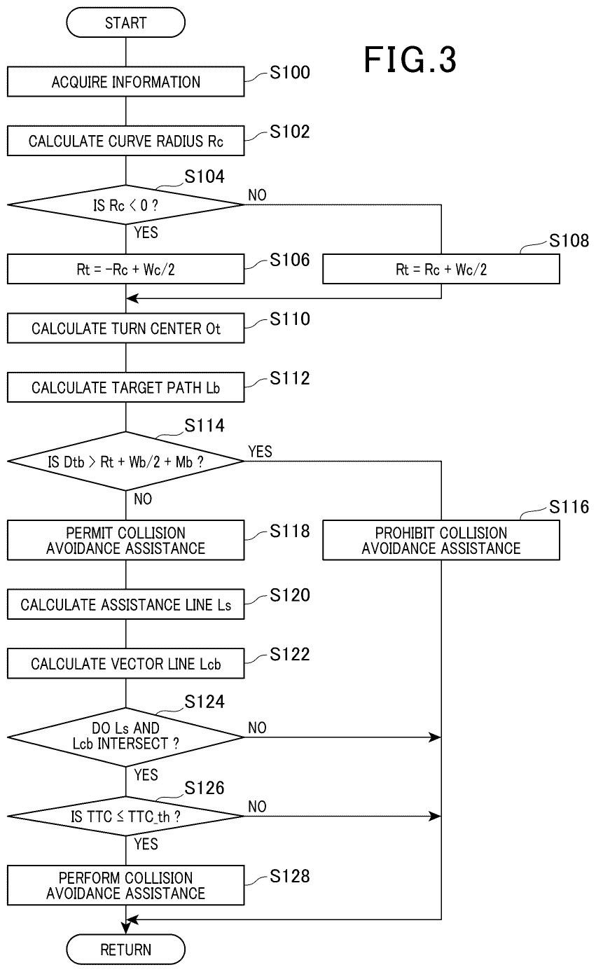

The own vehicle 10 in which the collision avoidance assistance apparatus 20 according to the first embodiment is used is configured as described above. Next, the collision avoidance assistance performed by the collision avoidance assistance apparatus 20 executing a program will be described with reference to a flowchart in FIG. 3. Here, for example, the program of the collision avoidance assistance apparatus 20 may be executed when a shift range of the own vehicle 10 is set to an R range. The R range is used for reverse travel.

At step S100, the collision avoidance assistance apparatus 20 acquires various pieces of information. Specifically, the collision avoidance assistance apparatus 20 acquires the position Pb of the target B, the width Wb of the target B, the target velocity vector Vb, and the relative velocity vector Vcb from the target detection apparatus 12. In addition, the collision avoidance assistance apparatus 20 acquires the vehicle speed Vc from the vehicle speed sensor 14. The collision avoidance assistance apparatus 20 also acquires the yaw rate Qc from the yaw rate sensor 16.

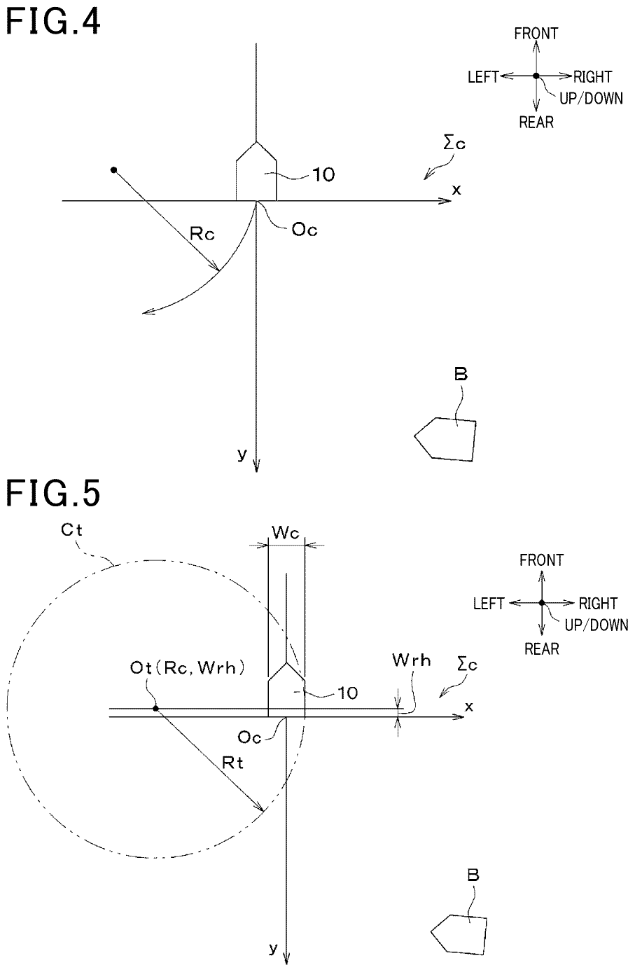

At step S102 following step S100, the collision avoidance assistance apparatus 20 calculates a curve radius Rc of the own vehicle 10 as shown in FIG. 4, from the vehicle speed Vc and the yaw rate Ωc acquired at step S100. The curve radius Rc is a radius of a predicted movement path of the center of the rear end of the own vehicle 10. In addition, here, for example, the curve radius Rc may be set to a negative value when the own vehicle 10 makes a rearward turn in a clockwise direction. The curve radius Rc may be set to a positive value when the own vehicle 10 makes a rearward turn in a counterclockwise direction. Furthermore, here, the curve radius Rc being zero is considered to be the rearward turn in the counterclockwise.

Returning to the flowchart in FIG. 3, at step S104 following step S102, the collision avoidance assistance apparatus 20 determines whether the curve radius Rc calculated at step S102 is less than zero. As a result, the collision avoidance assistance apparatus 20 determines whether a rearward turn direction of the own vehicle 10 is clockwise or counterclockwise.

When determined that the curve radius Rc is less than zero, because the curve radius Rc is a negative value, the collision avoidance assistance apparatus 20 determines that the rearward turn direction of the own vehicle 10 is clockwise. Subsequently, the process performed by the collision avoidance assistance apparatus 20 proceeds to step S106. In addition, when determined that the curve radius Rc is equal to or greater than zero, because the curve radius Rc is zero or a positive value, the collision avoidance assistance apparatus 20 determines that the rearward turn direction of the own vehicle 10 is counterclockwise. Subsequently, the process performed by the collision avoidance assistance apparatus 20 proceeds to step S108.

At step S106 following step S104, the collision avoidance assistance apparatus 20 calculates a turn radius Rt of the own vehicle 10 as shown in FIG. 5, using the curve radius Rc calculated at step S102, an own vehicle width Wc, and a relational expression (1), below. Subsequently, the process performed by the collision avoidance assistance apparatus 20 proceeds to step S110. Here, the own vehicle width Wc is a length of the own vehicle 10 in a lateral direction of the own vehicle 10. The own vehicle width Wc is a length that is set depending on a type of vehicle and the like, and is set in advance herein.

$$Rt = - Rc + ( Wc / 2 ) \qquad ( 1 )$$

At step S108 following step S104, the collision avoidance assistance apparatus 20 calculates the turn radius Rt of the own vehicle 10 using the curve radius Rc calculated at step S102, the own vehicle width Wc, and a relational expression (2), below. Subsequently, the process performed by the collision avoidance assistance apparatus 20 proceeds to step S110.

$$Rt = Rc + ( Wc / 2 ) \qquad ( 2 )$$

Returning to the flowchart in FIG. 3, at step S110, the collision avoidance assistance apparatus 20 calculates a turn center Ot as shown in FIG. 5, from the curve radius Rc calculated at step S102 and a rear overhang Wrh of the own vehicle 10. An x-coordinate of the turn center Ot is set to the curve radius Rc calculated at step S102. A y-coordinate of the turn center Ot is set to the rear overhang Wrh. The rear overhang Wrh is a distance from the rear end of the own vehicle 10 to a center of a rear wheel of the own vehicle 10 in a length direction of the own vehicle 10 when the own vehicle 10 is in an empty state. The rear overhang Wrh is a length that is set depending on the type of vehicle and the like, and here, is set in advance.

In addition, the collision avoidance assistance apparatus 20 calculates a turning circle Ct of which a center is the calculated turn center Ot and a radius is the calculated turn radius Rt. In this way, the collision avoidance assistance apparatus 20 calculates the turning circle Ct corresponding to a movement path when the own vehicle 10 makes a rearward turn.

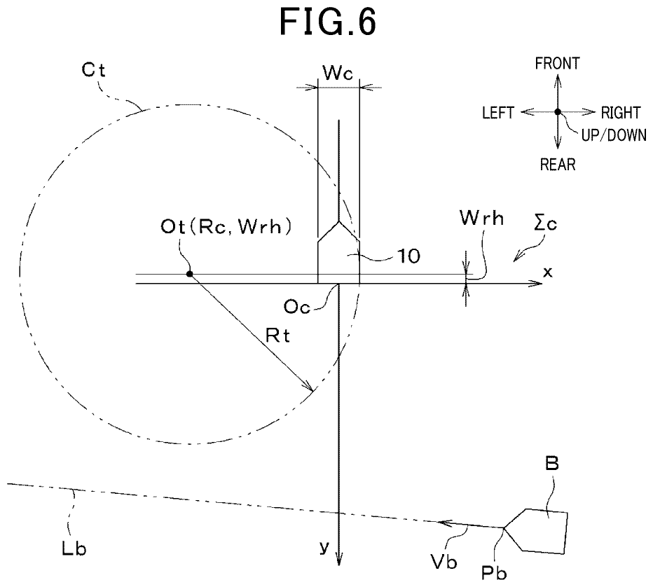

Returning to the flowchart in FIG. 3, at step S112 following step S110, the collision avoidance assistance apparatus 20 calculates a target path Lb. The target path Lb is a predicted movement path of the target B. In addition, here, the target path Lb is a straight line that extends in a direction of the target velocity vector Vb and passes through the position Pb of the target B. Therefore, the collision avoidance assistance apparatus 20 calculates the target path Lb as shown in FIG. 6, using the position Pb of the target B and the target velocity vector Vb acquired at step S100, and a relational expression (3), below.

In the relational expression (3), below, a is a value relating to a slope of a straight line obtained from the target velocity vector Vb. In the relational expression (3), below, b is a value relating to an intercept of the straight line derived from the obtained a and the position Pb of the target B. Therefore, the collision avoidance assistance apparatus 20 calculates the target path Lb by calculating a and b from the position Pb of the target B and the target velocity vector Vb.

$$a \times x - y + b = 0 \qquad ( 3 )$$

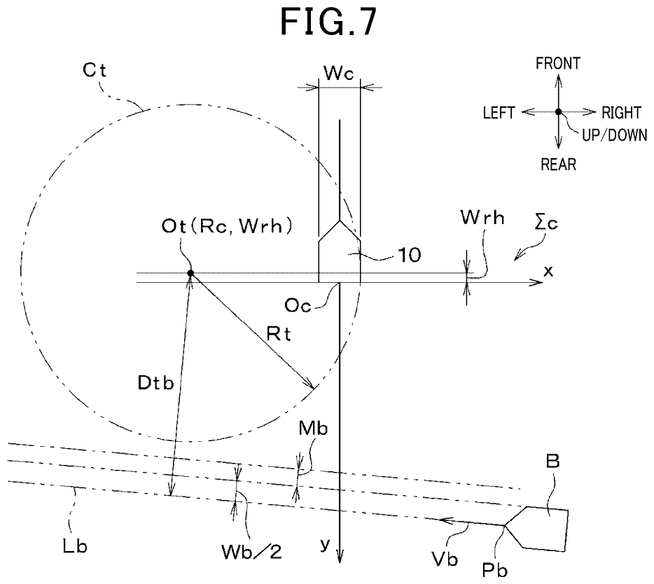

Here, as shown in FIG. 7, a shortest distance from the turn center Ot to the target path Lb is Dtb. When Dtb is greater than a sum of the turn radius Rt and half the width Wb of the target B, because the turning circle Ct and the target path Lb do not intersect, likelihood of a collision between the own vehicle 10 and the target B is low. As a result, at this time, collision avoidance assistance is not needed.

Therefore, at step S114 following step S112 in the flowchart in FIG. 3, the collision avoidance assistance apparatus 20 uses the turn center Ot calculated at step S110, a and b calculated at step S112, and a relational expression (4), below. The collision avoidance assistance apparatus 20 thereby calculates Dtb.

$$D t b = \frac{\vert a \times Rc - Wrh + b \vert}{\sqrt{{a}^{2} + 1}} \qquad ( 4 )$$

Furthermore, the collision avoidance assistance apparatus 20 determines whether a relational expression (5), below, is established using the calculated Dtb, the calculated turn radius Rt, the width Wb of the target B acquired at step S100, and a margin Mb. As a result, the collision avoidance assistance apparatus 20 determines whether the likelihood of a collision between the own vehicle 10 and the target object B is high. Here, the margin Mb corresponds to a predetermined value and is set in advance through experiments, simulations, and the like. For example, the margin Mb may be 0 m to 3 m.

$$Dtb > R t + ( Wb / 2 ) + M b \qquad ( 5 )$$

When the relational expression (5), above, is established, because the turning circle Ct and the target path Lb do not intersect, the collision avoidance assistance apparatus 20 determines that the likelihood of a collision between the own vehicle 10 and the target B is low. Subsequently, the process performed by the collision avoidance assistance apparatus 20 proceeds to step S116. Furthermore, when the relational expression (5), above, is not established, because likelihood of the turning circle Ct and the target path Lb intersecting is high, the collision avoidance assistance apparatus 20 determines that the likelihood of a collision between the own vehicle 10 and the target B is high. Subsequently, the process performed by the collision avoidance assistance apparatus 20 proceeds to step S118.

At step S116 following step S114, because the likelihood of a collision between the own vehicle 10 and the target B is low, and therefore collision avoidance assistance is not needed, the collision avoidance assistance apparatus 20 prohibits the collision avoidance assistance, described hereafter. As a result, unnecessary collision avoidance assistance is no longer performed. Subsequently, the process performed by the collision avoidance assistance apparatus 20 returns to step S100.

At step S118 following step S114, because the likelihood of a collision between the own vehicle 10 and the target B is high, the collision avoidance assistance apparatus 20 permits the collision avoidance assistance, described hereafter.

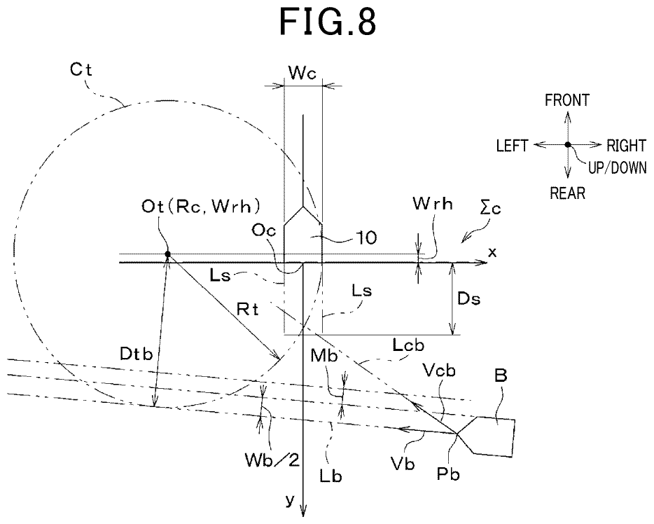

At step S120 following step S118, the collision avoidance assistance apparatus 20 calculates an assistance line Ls as shown in FIG. 8. The assistance line Ls is a straight line that extends in a longitudinal direction of the own vehicle 10 and passes through the own vehicle 10. For example, the assistance line Ls is x=±Wc/2 and 0≤y≤Ds.

At step S122 following step S120, the collision avoidance assistance apparatus 20 calculates a vector line Lcb using the position Pb and of the target B and the relative velocity vector Vcb acquired at step S100. The vector line Lcb is a straight line that extends in the direction of the relative velocity vector Vcb and passes through the position Pb of the target B.

Here, when the assistance line Ls and the vector line Lcb intersect, the likelihood of a collision between the own vehicle 10 and the target B is high.

Therefore, at step S124 following step S122 in the flowchart in FIG. 3, the collision avoidance assistance apparatus 20 determines whether the assistance line Ls calculated at step S120 and the vector line Leb calculated at step S122 intersect. As a result, the collision avoidance assistance apparatus 20 re-determines whether the likelihood of a collision between the own vehicle 10 and the target object B is high.

When determined that the assistance line Ls and the vector line Lcb do not intersect, the collision avoidance support apparatus 20 determines that the likelihood of a collision between the own vehicle 10 and the target object B is low. Subsequently, the process performed by the collision avoidance assistance apparatus 20 returns to step S100. In addition, when determined that the assistance line Ls and the vector line Lcb intersect, the collision avoidance support apparatus 20 determines that the likelihood of a collision between the own vehicle 10 and the target object B is high. Subsequently, the process performed by the collision avoidance assistance apparatus 20 proceeds to step S126.

At step S126 following step S124, the collision avoidance assistance apparatus 20 calculates a time-to-collision TTC between the own vehicle 10 and the target B using the position Pb of the target B and the relative velocity vector Vcb acquired at step S100. The time-to-collision TTC is a predicted amount of time required until the own vehicle 10 and the target B collide. Here, TTC is an abbreviation for time-to-collision.

In addition, the collision avoidance assistance apparatus 20 determines whether the calculated time-to-collision TTC is equal to or less than a time threshold TTC_th. As a result, the collision avoidance assistance apparatus 20 re-determines whether the likelihood of a collision between the own vehicle 10 and the target object B is high. Here, the time threshold TTC_th is set by experiments, simulations, and the like so that the collision avoidance assistance described hereafter is performed at an appropriate timing.

When determined that the time-to-collision TTC is greater than the time threshold TTC_th, the collision avoidance assistance apparatus 20 determines that the likelihood of a collision between the own vehicle 10 and the target B is low. Subsequently, the process performed by the collision avoidance assistance apparatus 20 returns to step S100. Furthermore, when determined that the time-to-collision TTC is equal to or less than the time threshold TTC_th, the collision avoidance assistance apparatus 20 determines that the likelihood of a collision between the own vehicle 10 and the target B is high. Subsequently, the process performed by the collision avoidance assistance apparatus 20 proceeds to step S128.

At step S128 following step S126, because the likelihood of a collision between the own vehicle 10 and the target B is high, the collision avoidance assistance apparatus 20 performs the collision avoidance assistance. For example, as the collision avoidance assistance, the collision avoidance assistance apparatus 20 may output a signal to the warning apparatus 30 to activate the warning apparatus 30. As a result, the warning apparatus 30 uses text display, sound, and light to notify the driver of the own vehicle 10 of a collision between the own vehicle 10 and an object.

Subsequently, the process performed by the collision avoidance assistance apparatus 20 returns to step S100. Here, at this time, as the collision avoidance assistance, the collision avoidance assistance apparatus 20 may output a signal to a braking apparatus (not shown) to brake the own vehicle 10. As a result, the own vehicle 10 may automatically stop before colliding with the target B by a braking force being applied to the wheels of the own vehicle 10.

The collision avoidance assistance apparatus 20 performs the collision avoidance assistance as described above. Next, the collision avoidance assistance apparatus 20 assisting in collision avoidance between the own vehicle 10 and the target B behind the own vehicle 10 when the own vehicle 10 makes a rearward turn will be described.

At step S100, the collision avoidance assistance apparatus 20 according to the present embodiment serves as an acquiring unit that acquires information relating to the target B behind the own vehicle 10 and information relating to the own vehicle 10. The information relating to the target B is the position Pb of the target B, the width Wb of the target B, the target velocity vector Vb, and the relative velocity vector Vcb. The information relating to the own vehicle 10 is the vehicle speed Vc and the yaw rate Ωc. In addition, the collision avoidance assistance apparatus 20 serves as an assisting unit that performs the collision avoidance assistance that is assistance relating to collision avoidance between the own vehicle 10 and the target B, based on the information relating to the target B and the information relating to the own vehicle 10.

Specifically, when the relational expression (5) above at step S114 is established, because the likelihood of a collision between the own vehicle 10 and the target B is low, the collision avoidance assistance apparatus 20 prohibits the collision avoidance assistance at step S116. Furthermore, when the relational expression (5) above at step S114 is not established, the assistance line Ls and the vector line Lcb at step S124 intersect, and the time-to-collision TTC at step S126 is equal to or less than the time threshold TTC_th, the collision avoidance assistance apparatus 20 performs the collision avoidance assistance.

As a result, assistance is provided for collision avoidance between the own vehicle 10 and the target B behind the own vehicle 10 when the own vehicle 10 makes a rearward turn.

### Second Embodiment

According to a second embodiment, the processes by the collision avoidance assistance apparatus 20 differ from those according to the first embodiment. Other configurations are similar to those according to the first embodiment.

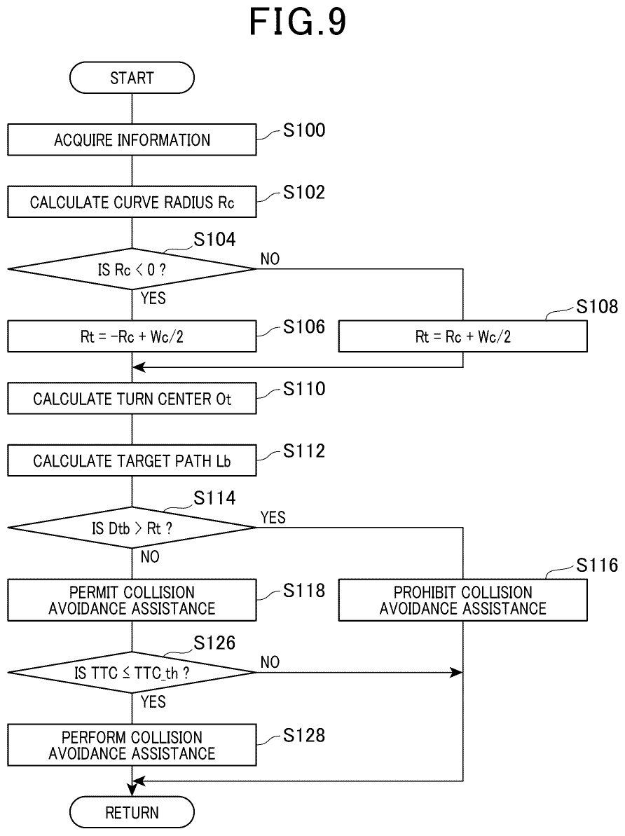

As shown in a flowchart in FIG. 9, at step S100, the collision avoidance assistance apparatus 20 acquires various pieces of information such as the position Pb of the target B. In addition, here, the position Pb of the target B is set to an end position of the target B on the own vehicle 10 side in the vehicle coordinate system Σc, instead of the center position on the front end of the target B in the vehicle coordinate system Σc. Furthermore, the collision avoidance assistance apparatus 20 performs the processes from step S102 following step S100 to step S110 in a manner similar to that according to the first embodiment.

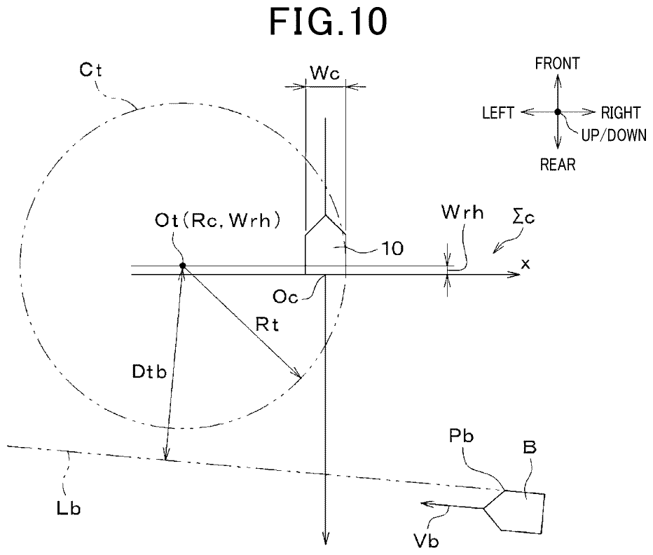

At step S112 following step S110, the collision avoidance assistance apparatus 20 calculates the target path Lb. At this time, because the position Pb of the target B is the end position of the target B on the own vehicle 10 side in the vehicle coordinate system Σc, the target path Lb is a straight line that passes through the end of the target B on the own vehicle 10 side and extends in the direction of the target velocity vector Vb. Therefore, the collision avoidance assistance apparatus 20 calculates the target path Lb as shown in FIG. 10, by calculating a and b using the end position of the target B on the own vehicle 10 side and the target velocity vector Vb acquired at step S100 and the relational expression (3), above.

Here, when Dtb is greater than the turn radius Rt, because the turning circle Ct and the target path Lb do not intersect, the likelihood of a collision between the own vehicle 10 and the target B is low. As a result, at this time, collision avoidance assistance is not needed.

Therefore, at step S114 following step S112 in the flowchart in FIG. 9, the collision avoidance assistance apparatus 20 uses the turn center Ot calculated at step S110, a and b calculated at step S112, and the relational expression (4) above. As a result, the collision avoidance assistance apparatus 20 calculates Dtb.

In addition, the collision avoidance assistance apparatus 20 determines whether a relational expression (6), below, is established using the calculated Dtb and the calculated turn radius Rt. As a result, the collision avoidance assistance apparatus 20 determines whether the likelihood of a collision between the own vehicle 10 and the target object B is high.

$$Dtb > R t \qquad ( 6 )$$

When the relational expression (6), above, is established, because the turning circle Ct and the target path Lb do not intersect, the collision avoidance assistance apparatus 20 determines that the likelihood of a collision between the own vehicle 10 and the target B is low. Subsequently, the process performed by the collision avoidance assistance apparatus 20 proceeds to step S116. In addition, when the relational expression (6), above, is not established, because the turning circle Ct and the target path Lb intersect, the collision avoidance assistance apparatus 20 determines that the likelihood of a collision between the own vehicle 10 and the target B is high. Subsequently, the process performed by the collision avoidance assistance apparatus 20 proceeds to step S118.

At step S116 following step S114, because the likelihood of a collision between the own vehicle 10 and the target B is low and therefore collision avoidance assistance is not needed, the collision avoidance assistance apparatus 20 prohibits the collision avoidance assistance. As a result, unnecessary collision avoidance assistance is not performed. Subsequently, the process performed by the collision avoidance assistance apparatus 20 returns to step S100.

At step S118 following step S114, because the likelihood of a collision between the own vehicle 10 and the target B is high, the collision avoidance assistance apparatus 20 permits the collision avoidance assistance. Subsequently, the process performed by the collision avoidance assistance apparatus 20 proceeds to step S126 without the calculation of the assistance line Ls at step S122 and the calculation of the vector line Lcb at step S124 being performed. The processes at steps S126 and S128 following step S118 are performed in a manner similar to that according to the first embodiment.

The collision avoidance assistance apparatus 20 according to the second embodiment performs the collision avoidance assistance as described above. In this way, the collision avoidance assistance apparatus 20 according to the second embodiment does not perform the collision avoidance assistance when the turning circle Ct and the target path Lb do not intersect and when the time-to-collision TTC is equal to or less than the time threshold TTC_th. In addition, the collision avoidance assistance apparatus 20 performs the collision avoidance assistance when the turning circle Ct and the target path Lb intersect, and the time-to-collision TTC is equal to or less than the time threshold TTC_th. According to the second embodiment as well, effects similar to those according to the first embodiment are obtained.

### OTHER EMBODIMENTS

The present disclosure is not limited to the above-described embodiments, and the above-described embodiments can be modified as appropriate. In addition, it goes without saying that an element configuring the above-described embodiments is not necessarily a requisite unless particularly specified as being a requisite, clearly considered a requisite in principle, or the like.

An acquiring unit, an assisting unit, and the like, and a method thereof described in the present disclosure may be implemented by a dedicated computer that is provided so as to be configured by a processor and a memory, the processor being programmed to provide one or more functions that are implemented by a computer program. Alternatively, the acquiring unit, the assisting unit, and the like, and a method thereof described in the present disclosure may be implemented by a dedicated computer that is provided by a processor being configured by one or more dedicated hardware logic circuits. Still alternatively, the acquiring unit, the assisting unit, and the like, and a method thereof described in the present disclosure may be actualized by one or more dedicated computers. The dedicated computer may be configured by a combination of a processor that is programmed to provide one or more functions, a memory, and a processor that is configured by one or more hardware logic circuits. In addition, the computer program may be stored in a non-transitory, computer-readable, tangible storage medium that can be read by a computer as instructions performed by the computer.

According to the above-described embodiments, the target path Lb is a straight line that extends in the direction of the target velocity vector Vb and passes through the position Pb of the target B. In contrast, rather than being limited to the straight line, the target path Lb may be a curve that passes through the position Pb of the target B. When the target path Pb is a curve, for example, the target path Lb may be calculated from a movement history of the target B.

The above-described embodiments may be combined as appropriate.

### Aspects of the Present Disclosure

### [Aspect 1]

A collision avoidance assistance apparatus including: at least one of (i) a circuit and (ii) a processor with a memory storing computer program code executable by the processor, the at least one of the circuit and the processor configured to implement: an acquiring unit (20) that acquires information relating to a target (B) behind an own vehicle (10) and information relating to the own vehicle; and an assisting unit (20) that performs collision avoidance assistance that is assistance relating to collision avoidance between the own vehicle and the target, based on the information relating to the target and the information relating to the own vehicle, in which the assisting unit does not perform the collision avoidance assistance in response to a turning circle (Ct) and a target path (Lb) not intersecting, and a time-to-collision (TTC) between the own vehicle and the target being equal to or less than a time threshold (TTC_th), where the turning circle corresponds to a movement path when the own vehicle makes a rearward turn, and the target path (Lb) is a movement path of the target not intersecting, and the assisting unit performs the collision avoidance assistance in response to the turning circle and the target path intersecting and the time-to-collision being equal to or less than the time threshold.

### [Aspect 2]

The collision avoidance assistance apparatus according to the aspect 1, in which: the collision avoidance assistance is issuing a warning.

### [Aspect 3]

The collision avoidance assistance apparatus according to the aspect 1 or 2, in which: the turning circle has a turn radius (Rt) that is derived from a value relating to a vehicle speed (Vc) of the own vehicle, a value relating to a yaw rate of the own vehicle (Ωc), and a value relating to a length (Wc) of the own vehicle in a lateral direction of the own vehicle, and a turn center (Ot) that is derived from the value relating to the vehicle speed, the value relating to the yaw rate, and a value relating to a rear overhang (Wrh) of the own vehicle, and the target path is a straight line that extends in a direction of a velocity vector (Vb) of the target and passes through the target.

### [Aspect 4]

The collision avoidance assistance apparatus according to the aspect 3, in which: the target path is a straight line that passes through a center position of the target; and the assisting unit does not perform the collision avoidance assistance in response to a distance (Dtb) from the turn center to the target path being greater than a sum of the turn radius, half of a length (Wb) of the target in a direction perpendicular to the direction of the velocity vector of the target and a predetermined value (Mb), and the time-to-collision being equal to or less than the time threshold, and performs the collision avoidance assistance in response to the distance (Dtb) from the turn center to the target path being equal to or less than the sum of the turn radius, half the length (Wb) of the target in the direction perpendicular to the direction of the velocity vector of the target, and the predetermined value (Mb), and the time-to-collision being equal to or less than the time threshold.

### [Aspect 5]

The collision avoidance assistance apparatus according to any one of the aspects 1 to 4, in which: the assisting unit performs the collision avoidance assistance in response to an assistance line (Ls) and a vector line (Lcb) intersecting, where the assistance line is a straight line that extends in a longitudinal direction of the own vehicle and passes through the own vehicle, and the vector line is a straight line that extends in a direction of a relative velocity vector (Vcb) of the target relative to the own vehicle and passes through the target.

### [Aspect 6]

A collision avoidance assistance method including: acquiring information relating to a target (B) behind an own vehicle (10) and information relating to the own vehicle; and performing collision avoidance assistance that is assistance relating to collision avoidance between the own vehicle and the target, based on the information relating to the target and the information relating to the own vehicle, in which performing the collision avoidance assistance includes not performing the collision avoidance assistance in response to a turning circle (Ct) and a target path (Lb) not intersecting, and a time-to-collision (TTC) between the own vehicle and the target being equal to or less than a time threshold (TTC_th), where the turning circle (Ct) corresponds to a movement path when the own vehicle makes a rearward turn, and the target path (Lb) is a movement path of the target, and performing the collision avoidance assistance in response to the turning circle and the target path intersecting and the time-to-collision being equal to or less than the time threshold.

### [Aspect 7]

A non-transitory computer-readable storage medium storing therein a collision avoidance assistance program that causes a collision avoidance assistance apparatus to function as: an acquiring unit (20) that acquires information relating to a target (B) behind an own vehicle (10) and information relating to the own vehicle; and an assisting unit (20) that performs collision avoidance assistance that is assistance relating to collision avoidance between the own vehicle and the target, based on the information relating to the target and the information relating to the own vehicle, in which the assisting unit does not perform the collision avoidance assistance in response to a turning circle (Ct) and a target path (Lb) not intersecting, and a time-to-collision (TTC) between the own vehicle and the target being equal to or less than a time threshold (TTC_th), where the turning circle (Ct) corresponds to a movement path when the own vehicle makes a rearward turn, and the target path (Lb) is a movement path of the target, and the assisting unit performs the collision avoidance assistance in response to the turning circle and the target path intersecting and the time-to-collision being equal to or less than the time threshold.

What is claimed is:

1. A collision avoidance assistance apparatus comprising:
at least one of (i) a circuit and (ii) a processor with a memory storing computer program code executable by the processor, the at least one of the circuit and the processor configured to implement:
an acquiring unit that acquires information relating to a target behind an own vehicle and information relating to the own vehicle; and
an assisting unit that performs collision avoidance assistance that is assistance relating to collision avoidance between the own vehicle and the target, based on the information relating to the target and the information relating to the own vehicle, wherein
the assisting unit does not perform the collision avoidance assistance in response to a turning circle and a target path not intersecting, and a time-to-collision between the own vehicle and the target being equal to or less than a time threshold, where the turning circle corresponds to a movement path when the own vehicle makes a rearward turn, and the target path is a movement path of the target not intersecting, and
the assisting unit performs the collision avoidance assistance in response to the turning circle and the target path intersecting and the time-to-collision being equal to or less than the time threshold.

2. The collision avoidance assistance apparatus according to claim 1, wherein:
the collision avoidance assistance is issuing a warning.

3. The collision avoidance assistance apparatus according to claim 1, wherein:
the turning circle has
a turn radius that is derived from a value relating to a vehicle speed of the own vehicle, a value relating to a yaw rate of the own vehicle, and a value relating to a length of the own vehicle in a lateral direction of the own vehicle, and
a turn center that is derived from the value relating to the vehicle speed, the value relating to the yaw rate, and a value relating to a rear overhang of the own vehicle, and
the target path is a straight line that extends in a direction of a velocity vector of the target and passes through the target.

4. The collision avoidance assistance apparatus according to claim 3, wherein:
the target path is a straight line that passes through a center position of the target; and
the assisting unit
does not perform the collision avoidance assistance in response to a distance from the turn center to the target path being greater than a sum of the turn radius, half of a length of the target in a direction perpendicular to the direction of the velocity vector of the target and a predetermined value, and the time-to-collision being equal to or less than the time threshold, and
performs the collision avoidance assistance in response to the distance from the turn center to the target path being equal to or less than the sum of the turn radius, half the length of the target in the direction perpendicular to the direction of the velocity vector of the target, and the predetermined value, and the time-to-collision being equal to or less than the time threshold.

5. The collision avoidance assistance apparatus according to claim 1, wherein:
the assisting unit performs the collision avoidance assistance in response to an assistance line and a vector line intersecting, where the assistance line is a straight line that extends in a longitudinal direction of the own vehicle and passes through the own vehicle, and the vector line is a straight line that extends in a direction of a relative velocity vector of the target relative to the own vehicle and passes through the target.

6. The collision avoidance assistance apparatus according to claim 2, wherein:
the assisting unit performs the collision avoidance assistance in response to an assistance line and a vector line intersecting, where the assistance line is a straight line that extends in a longitudinal direction of the own vehicle and passes through the own vehicle, and the vector line is a straight line that extends in a direction of a relative velocity vector of the target relative to the own vehicle and passes through the target.

7. The collision avoidance assistance apparatus according to claim 3, wherein:
the assisting unit performs the collision avoidance assistance in response to an assistance line and a vector line intersecting, where the assistance line is a straight line that extends in a longitudinal direction of the own vehicle and passes through the own vehicle, and the vector line is a straight line that extends in a direction of a relative velocity vector of the target relative to the own vehicle and passes through the target.

8. The collision avoidance assistance apparatus according to claim 4, wherein:
the assisting unit performs the collision avoidance assistance in response to an assistance line and a vector line intersecting, where the assistance line is a straight line that extends in a longitudinal direction of the own vehicle and passes through the own vehicle, and the vector line is a straight line that extends in a direction of a relative velocity vector of the target relative to the own vehicle and passes through the target.

9. A collision avoidance assistance method comprising:
acquiring information relating to a target behind an own vehicle and information relating to the own vehicle; and
performing collision avoidance assistance that is assistance relating to collision avoidance between the own vehicle and the target, based on the information relating to the target and the information relating to the own vehicle, wherein
performing the collision avoidance assistance comprises
not performing the collision avoidance assistance in response to a turning circle and a target path not intersecting, and a time-to-collision between the own vehicle and the target being equal to or less than a time threshold, where the turning circle corresponds to a movement path when the own vehicle makes a rearward turn, and the target path is a movement path of the target, and
performing the collision avoidance assistance in response to the turning circle and the target path intersecting and the time-to-collision being equal to or less than the time threshold.

10. A non-transitory computer-readable storage medium storing therein a collision avoidance assistance program that causes a collision avoidance assistance apparatus to function as:
an acquiring unit that acquires information relating to a target behind an own vehicle and information relating to the own vehicle; and
an assisting unit that performs collision avoidance assistance that is assistance relating to collision avoidance between the own vehicle and the target, based on the information relating to the target and the information relating to the own vehicle, wherein
the assisting unit does not perform the collision avoidance assistance in response to a turning circle and a target path not intersecting, and a time-to-collision between the own vehicle and the target being equal to or less than a time threshold, where the turning circle corresponds to a movement path when the own vehicle makes a rearward turn, and the target path is a movement path of the target, and
the assisting unit performs the collision avoidance assistance in response to the turning circle and the target path intersecting and the time-to-collision being equal to or less than the time threshold.
